(19) United States
(12) Patent Application Publication
(10) Pub. No.: US 2019/0359860 A1
(43) Pub. Date: Nov. 28, 2019

(54) ADHESIVE TAPE

(71) Applicant: TESA SE, Norderstedt (DE)

(72) Inventors: Anna SCHUBERT, Hamburg (DE); Kerstin KLINGEBERG, Hamburg (DE); Ingo NEUBERT, Norderstedt (DE)

(21) Appl. No.: 16/479,411

(22) PCT Filed: Feb. 26, 2018
(86) PCT No.: PCT/EP2018/054642

§ 371 Date: Jul. 19, 2019

(30) Foreign Application Priority Data
Feb. 24, 2017 (DE) 10 2017 203 066.6

(51) Int. Cl. C09J 7/24; C08L 23/14; B65D 63/10

(52) U.S. Cl. CPC C09J 7/243; C08L 23/14; B65D 63/1009; C09J 2205/114; C08L 2205/03; C09J 2423/166; C09J 2407/00; C09J 2421/00; C09J 2423/106

(57) ABSTRACT

The invention relates to an adhesive tape comprising a backing consisting of a film, to at least one side of which an adhesive mass is applied, wherein the film is a monoaxially stretched film, at least 95 wt. % of which, preferably at least 99 wt. % of which, particularly preferably 100 wt. % of which consists of a propylene polymer composition having different phases and comprising the following components: i) 80 to 99 wt. %, preferably 93 to 96 wt. %, relative to the total weight of components i) and ii), of a propylene polymer matrix which comprises a propylene homopolymer and particularly preferably a propylene copolymer, preferably a propylene random copolymer, which has a comonomer selected from ethylene or C₄- to C₁₀-α-olefins, the propylene polymer matrix having a comonomer content of not more than 15 wt. %, ii) 1 to 20 wt. %, preferably 4 to 7 wt. %, relative to the total weight of components i) and ii), of an elastomer in the form of an ethylene-propylene copolymer having an ethylene content of 50 to 90 wt. %.

The invention relates to an adhesive tape.

Adhesive strapping tapes so called are suitable particularly for bundling articles. Examples of such articles include pipes, profiles, or stacked cardboard boxes (strapping application). The strapping applications further include the fastening of moving parts on white goods (such as refrigerators and freezers or air-conditioning units), on red goods such as (gas) ovens, and, generally, on electrical equipment such as printers, for example.

In the technical jargon, the sectors are designated as follows:
Appliance Sector: fastening of moving parts of refrigerators and freezers and other household appliances such as gas ovens, etc.
Office Automation Sector: fastening of moving parts of printers, copiers, etc.

Further applications for adhesive tapes of these kinds are
a) the temporary fastening of relatively large components such as auto windshields, for example, following insertion into the frame, until the liquid PU adhesive has cured, to prevent slippage during the curing process,
b) the endtabbing (end-ply bonding) of metal coils, with the requirement for residue-free redetachability even at low temperatures,
c) the temporary sealing of containers or general bonding to surfaces, with the requirement for residue-free redetachability even at low temperatures.

The residue-free removability (redetachability) of a (strapping) tape from a variety of substrates is dependent essentially on the peel forces which develop after different periods of time, when the tape is detached from the substrates in question. Ideally, the peel force, in comparison to the initial force, increases only slightly or even not at all, since with increasing peel force there is an increase in the risk either of the carrier tearing or of residues remaining. Hence, in the case of forces that are too high, the film carrier may fail and tear and/or splay. Other results of excessively high peel forces may be either the cohesive splitting of the adhesive or else the adhesive failure of the adhesive as a result of detachment from the carrier.

In all cases, unwanted residues of the adhesive tape are produced on the substrate, whether in the form of parts of the tape itself or of parts of the adhesive.

There is, consequently, a need for an adhesive strapping tape which can be employed universally across all substrates relevant to the application, examples being plastics ABS, PS, PP, PE, PC and POM, and also various metals, and solventborne, waterborne and powder-applied coatings and other solvent-free coatings (for example, UV-curing coatings), this tape at the same time bonding securely to these substrates, with sufficiently high peel adhesion forces of, in general, at least 2.5 N/cm, yet nevertheless being removable without residue or damage even after prolonged storage at different temperatures (temperature range: −20° C. to +60° C.) and under UV irradiation.

Although adhesive strapping tapes are utilized across a great variety of applications, they have certain key properties allowing them to meet the particular requirements to which they are subject. These properties—without making any claim to completeness—include very high tensile strength (ultimate tensile force), a very good stretch resistance, corresponding to a high modulus at low levels of elongation, and a low elongation at break, a sufficient but not excessive peel adhesion, a graduated peel adhesion to the tape's own reverse, residue-free redetachability after the stresses of the application itself, robustness of the carrier with respect to mechanical load, and also, for certain applications, the resistance of the adhesive tape toward UV irradiation and to numerous chemicals.

Whereas some of the properties can be attributed to the adhesive or to other functional layers of the adhesive tape, the stretchability and the tensile strength are based substantially on the physical properties of the carrier material used.

It would be remiss at this point not to mention another disadvantage of the increased peel adhesion forces of adhesive strapping tapes. That disadvantage is that the increase in the peel adhesion forces is accompanied by an increased risk of damaging the substrate on removal, through lifting of paint coatings, for example.

Particularly in the event of rapid removal at acute angles which, while unfavorable, are nevertheless encountered in practice, it is possible that in the case of adhesive strapping tapes, even with rate-dependent peel adhesion forces of more than about 3 N/cm, for the adhesive tape carrier to break in the z-direction and splay, known as shredding. At the same time, such peel adhesion forces also impose increased requirements on the effectiveness of the primer and/or on the anchorage of the adhesive on the film carrier, and on the cohesion of the adhesive. The problem becomes more acute at low temperatures of less than 0° C. Even at these low temperatures, the adhesive tape must not exhibit shredding.

An adhesive tape intended for use as adhesive (strapping) tape ought therefore to exhibit the following properties:
The adhesive tape must secure loose parts during transit; that is, the adhesive tape ought to have a high tear resistance in machine direction and sufficient peel adhesion forces.
The adhesive tape must not stretch greatly under load; that is, the adhesive tape ought—insofar as they are determinable—to have high F5% values (high values for the tensile strength at 5% elongation) or a high modulus of elasticity.
The adhesive tape must function under a variety of climatic conditions; that is, the adhesive tape ought to have a climatic resistance in the temperature range between −20° C. to 40° C. and a relative humidity of up to 95%.
The adhesive tape ought to be repeelable in the temperature range between −20° C. to 40° C. and a relative humidity of up to 95%.
The adhesive tape ought to be heat-stable when the coating of adhesive is dried in the process of producing the adhesive tape.
The adhesive tape ought to be easy to use; that is, the adhesive tape ought preferably to have a low unwind force, a feature being ensurable in particular via the use of a carbamate or silicone release.

The adhesive tape ought to bond well to a variety of substrates, and have sufficient cohesion to secure the goods under transit; that is, the adhesive tape may have an adhesive based on natural rubber, SIS rubber, or acrylate.

The prior art encompasses adhesive tapes which are used in the sectors of strapping (bundling), appliance (in-transit securement of movable parts such as drawers, shelves, flaps, particularly in household appliances, etc.) and in the furniture industry and which when used for other applications exhibit weaknesses when the adhesive tape is peeled from the substrate in the lower temperature range (below about 10° C.).

There are primarily two different films which are employed as carrier materials for adhesive strapping tapes:
i) biaxially oriented PET films having a thickness of between 30 and 60 μm
ii) monoaxially oriented PP films having a thickness of between 40 and 150 μm

As is known, biaxially oriented PET carriers prove advantageous relative to monoaxially oriented PP (MOPP) carriers by virtue of the greater split resistance at low temperatures, but they do tear earlier in the longitudinal direction (MD; machine direction) than MOPP, and are more expensive and are colorless in their usual market form. Coloring the adhesive tape based on a PET film is accomplished via a subsequent printing operation or by coloring of the adhesive. Monoaxially oriented PP films, on the other hand, are more favorably priced and are easy to color (easily perceptible), this being a general requirement for adhesive tapes which are to be removed again. In application, the high modulus of elasticity under tensile load for both types of films makes them less stretchable, and therefore highly suitable. MOPP adhesive strapping tapes are used generally for the wrapping of palletized cardboard boxes; the film does not split when detached, because the paper splits readily at the surface. Using MOPP film for adhesive surface-protection tapes has been possible to date only if the adhesion of the adhesive is weak enough to leave behind neither adhesive nor adhesive-tape remnant with film fraction. The requirement, therefore, is to provide an adhesive tape for surface-protection applications, as for example as in-transit securement for PC printers, refrigerators, electrical and gas ovens or furniture, that has a high adhesion but is residuelessly removable and has these qualities also, in particular, at below usual room temperature—in other words, for example, between −20° C. and +7° C. Falling temperature is accompanied by a drop in the toughness of a polypropylene film and at the same time by an increase in the peel adhesion of the adhesive. The challenge is to minimize this low-temperature behavior and, through a suitable combination of film and adhesive, to find a solution which achieves the technical object.

Many of the known adhesive strapping tapes possess a monoaxially oriented polypropylene (MOPP) carrier, since MOPP possesses very high force absorption in machine direction (MD). Because of the orientation in the machine direction (x-direction, MD), there is a decrease in the toughness of the MOPP carrier in the y-direction (cross direction, CD) and z-direction (the thickness of the film is determined in the z-direction), and hence the internal strength of the MOPP becomes the weak point. Consequently, the carrier frays out, leaving the adhesive and film remnants on the substrate; this is a frequent ground for complaint.

The weak point of MOPP is the low strength transversely to the machine direction (CD) and within the film in the z-direction. This effect is intensified at lower temperatures (−20° C.), since the temperatures reach or fall below the glass transition temperature of polypropylene (which is between 0 and −20° C.) and the carrier becomes very brittle. This effect is particularly pronounced when a PP homopolymer is used, since the regular arrangement of the polymer chains produces a high crystallinity, making the film very firm, stiff and brittle. Particularly for applications at low temperatures there are heterophasic PP copolymers where an ethylene-propylene copolymer (EP phase) is incorporated in finely divided form, and/or polymerized, in the PP homopolymer matrix. The presence of the EP phase raises the toughness of the PP copolymer.

Heterophasic polypropylenes or polypropylenes with different phases, especially propylene copolymers with different phases, in other words polymers containing a propylene polymer matrix and an elastomer, are known.

The use of a relatively soft carrier is known. On a standard basis, polyethylene is admixed to this carrier in order to lower the glass transition temperature and to retain a higher flexibility on the part of the carrier at relatively low temperatures. As a result, the tendency for the carrier to fray out at lower temperatures is remediated, but cannot be completely eliminated. A disadvantageous effect here, however, is a reduction in the strength of such a film. In order to be able to provide a robust and shredding-free solution, an adhesive with lower peel adhesion forces at low temperatures is used on the adhesive tape. Since, however, the market requirement tends to be for higher peel adhesion forces at low temperatures, in order to be able to ensure in-transit securement, it is necessary to select a different carrier.

A problem frequently occurring with MOPP films, besides the shredding on removal of the adhesive tape, is the appearance of fibers during the slitting and converting operation. The fibers formed have a strong influence on operational reliability, production rate and product quality. By means of fiber-free films it is possible to boost the production rate by at least 100%, if not indeed 400% or more. Furthermore, the operation becomes more efficient, with the need for costly and inconvenient cleaning removed. If an optical fault recognition system is employed in production, the occurrence of fibers and fiber agglomerates often triggers error recognition and so leads to downtimes in the production operation.

It is an object of the invention to obtain a marked improvement over the prior art and to provide an adhesive tape which exhibits reduced splitting when the adhesive tape is peeled off under cold conditions in a temperature range between −20° C. and up to +7° C., the intention being more particularly to improve the low-temperature split resistance in cross- and z-directions when the carrier is loaded suddenly.

This object is achieved by an adhesive tape as characterized more closely in the main claim. The dependent claims describe advantageous embodiments of the invention. Likewise embraced is the use of the adhesive tape of the invention.

The invention relates accordingly to an adhesive tape having a carrier composed of a film bearing on at least one side an applied adhesive, where the film is a monoaxially (in machine direction) oriented film which consists to an extent of at least 95 wt %, preferably 99 wt %, more preferably 100 wt %, of a propylene polymer composition which has different phases and which comprises the following components:
i) 80 to 99 wt %, preferably 93 to 96 wt %, based on the total weight of components i) and ii), of a propylene polymer matrix which comprises a propylene homopolymer and further preferably a preferably random propylene copolymer having a comonomer which is selected from ethylene or C₄ to C₁₀ α-olefins, the comonomer content of the propylene polymer matrix being not more than 15 wt %;
ii) 1 to 20 wt %, preferably 4 to 7 wt %, based on the total weight of components i) and ii), of an elastomer in the form of an ethylene-propylene copolymer having an ethylene content of 50 to 90 wt %.

The fractions required to make up 100 wt % in the film may consist of the components mentioned later that are to be added to the propylene polymer composition.

With further preference the propylene polymer composition consists only of components i) and ii). Further polymers are in that case not present in the matrix.

The propylene polymer matrix (component i) may comprise a pure propylene homopolymer or preferably a mixture of propylene homopolymer and of a preferably random propylene copolymer, and preferably may consist of the propylene homopolymer or of this mixture. The mixture of propylene homopolymer and of a preferably random propylene copolymer is known as heterophasic propylene copolymer (also as impact polypropylene).

According to one particularly advantageous embodiment, the fractions of propylene homopolymer and of propylene copolymer in the propylene polymer matrix are distributed as follows:
70 to 99 wt % propylene homopolymer and
1 to 30 wt % propylene copolymer

The propylene polymer matrix, according to one preferred variant, has a melt flow index WI of 0.5 to 5 g/10 min (measured according to ISO 1133 at 230° C. and under a weight of 2.16 kg), preferably 1 to 5 g/10 min, a molar weight M_{w} of 500 000 to 1 000 000 g/mol and a flexural elasticity modulus of 1000 to 1300 MPa.

The matrix polymer preferably comprises at least two polypropylenes. If the matrix polymer comprises more different propylene polymers, these polymers may have different molecular weight distributions. These components may have an identical or a different tacticity.

The matrix polymer can be produced in a polymerization stage which is carried out in one or more polymerization reactors, or by mixing two or more compatible polymers having the desired molecular weight distribution or monomer composition. Desirably it is possible for a matrix polymer comprising two or more different propylene polymers to be prepared through the use of two or more types of catalyst in a polymerization in a reactor, or, alternatively, by implementing the polymerization in two or more different polymerization rectors (for example bulk, suspension and/or gas-phase reactors; preferred bulk reactors are reactors with a closed circuit) so as to produce, in the different polymerization reactors, matrix polymers having the desired different molecular weight distribution or monomer composition. The latter method is preferred.

The matrix consists preferably of a propylene homopolymer and of a preferably random propylene copolymer. The comonomers are selected from ethylene and C₄ to C₁₀ α-olefins.

Ethylene is a particularly preferred comonomer selected. The comonomer content (based on the propylene polymer matrix (component i)), preferably ethylene content, is up to 15 wt %, preferably 3 to 8 wt %. Very preferably the propylene polymer matrix (component i)) consists of a heterophasic propylene copolymer (also known as impact polypropylene).

In accordance with the invention the term “homopolymer” is utilized to signify a polymer wherein at least 99 wt % originates from a single monomer and the polymer chain has a high isotacticity of at least 95%.

Polymers having the desired properties for the components of the matrix polymer can be prepared by employing processes that are general knowledge to the skilled person—for example, by suitable selection of the catalyst systems (for example, Ziegler-Natta catalysts or metallocene catalysts or other catalysts with unitary active centers), the comonomers, the nature of the polymerization reactor, and the conditions of the polymerization process. With particular preference the matrix polymer is prepared in a polymerization process which uses a supported Ziegler-Natta catalyst system (more particularly a Ziegler-Natta system for a high yield that comprises Ti, Cl, Mg and Al). Metallocene catalysts can also be used.

The second component (component ii)) of the polymer composition of the invention with different phases is the elastomer in the form of an ethylene-propylene copolymer having an ethylene content of 50 to 90 wt %.

Ethylene-propylene elastomers, also known as ethylene-propylene rubber, EPM or EPR, are nowadays available in a wide spread of variations. Typically the ethylene-propylene elastomers have an ethylene content of 45 to 80 wt %, are available in a wide viscosity range or molecular weight range, and as a further monomer may comprise a diene monomer (as EPDM, subsequently vulcanizable). The ethylene-propylene rubbers may be amorphous and semi crystalline. This is dependent on the ethylene-propylene proportions in the polymer. In the range from 45 to 55 wt % ethylene, the polymer is amorphous and non-crystalline. At a fraction of greater than 65 wt % of ethylene, pronounced ethylene crystallites develop. The ethylene-propylene rubbers are produced typically in the solvent process, suspension process (also called slurry process) and gas-phase process, using Ziegler-Natta catalysts or, less often, using metallocene catalysts.

According to one preferred embodiment of the invention, the ethylene content of component ii) is 55 to 80 wt % and more preferably 65 to 75 wt %.

With further preference
the value for the elasticity modulus is 25 to 150 MPa,
the softening point is less than 70° C. (measured by DSC),
the melt flow index MFI is less than 10 g/10 min, preferably less than 5 g/10 min (measured according to ISO 1133 at 190° C. and under a weight of 2.16 kg), and/or
the degree of crystallinity α is 0.1

As for the matrix polymer, the elastomer may be prepared by conventional processes for polymerization in the gas phase. It is, however, preferably prepared using a supported catalyst system, as for example a Ziegler-Natta catalyst system or a catalyst system comprising metallocene-aluminoxane.

The elastomer (component ii)) may be mixed with the matrix polymer (component i)). This mixing or blending of the two components may advantageously take place directly in the melting extruder for producing the polymer film. For this purpose it is customary to use a single-screw extruder. Alternatively, the components may be mixed in a separate step, with the aid of a twin-screw extruder, for example.

According to one preferred embodiment, the composition of the invention is produced by a process which comprises the following steps:
a) polymerizing propylene in a first reactor, to produce a first homopolymer;
b) further polymerizing propylene and a comonomer, selected from especially ethylene and C₄ to C₁₀ α-olefins, in a further reactor in the presence of the first polymer, to produce a mixture of the first polymer and a second polymer;
c) mixing or blending, or combinedly mixing or blending, component i) from a)+b) with an elastomer (component ii)) in the form of an ethylene-propylene copolymer with an ethylene content of 50 to 90 wt %, preferably 55 to 80 wt % and more preferably 65 to 75 wt %.

In steps a) and b) of this process, in which the propylene polymer matrix is produced, the polymerizations are carried out preferably in bulk reactors (for example, reactors with a closed circuit), suspension reactor—the so-called slurry process—or gas-phase reactors. An overview of suitable production processes is found in Ullmann's “Encyclopedia of Industrial Chemistry”, entry heading “Polypropylene” by M. Gahleitner and C. Paulik, Wiley-VCH Verlag GmbH & CO KGaA, Weinheim 2014 (number 10.1002/14356007.o21_o04. pub2).

Besides the matrix polymer component i) and the elastomer component ii), the polymer composition of the invention may comprise other components, examples being conventional additions such as dyes, crystallization nucleators, fillers, antioxidants, radiation stabilizers, process assistants, etc. The use of inorganic, organic or polymeric nucleators is particularly preferred. The stated additions are preferably used in an additional polymer, as a masterbatch.

The polymer composition of the invention can be prepared for use by mixing the components preferably in an extruder. The mixing or blending of components i) and ii) and also of the additional components may advantageously take place directly in the melting extruder for producing the polymer film. For this purpose it is customary to use a single-screw extruder. Alternatively, the components may be mixed in a separate step, by means of a twin-screw extruder, for example.

The film of the adhesive tape of the invention is obtained by extrusion and orientation in the longitudinal direction, using customary methods which are general knowledge.

The draw ratio on orientation of the extruded primary film in the longitudinal direction (machine direction) is preferably 1:5 to 1:9, more preferably 1:6 to 1:8. A 1:6 draw ratio indicates that, from a section of the film with a length, for example, of 1 m, an oriented film section with a length of 6 m is produced. Orientation takes place without any substantial decrease in the width of the primary film, primarily at the expense of the thickness of the film.

The customary film thickness after orientation is in this case between 40 and 150 μm. 50 to 100 μm are preferred.

The monoaxially oriented film of the invention made from the components i) and ii) is distinguished by a degree of crystallization a of 0.4 to 0.5.

In general there is at least one corona pretreatment or else flame pretreatment of the side of the film carrier that is intended for subsequent coating with the adhesive, in order to anchor the adhesive more effectively on the carrier. Another improvement in adhesion synonymous with the anchorage of the adhesive on the carrier may be accomplished through the use of primers. With these it is possible first to targetedly adjust the surface energy and second, when using isocyanate-containing primers, for example, to pursue chemical attachment of the elastomeric adhesive component to the carrier.

The customary weight per unit area at which the primer is applied is between 0.1 and 10 g/m². Another means of enhancing the anchorage is to use carrier films which at the premises of the film manufacturer are deliberately equipped, by coextrusion, with a polymer surface favorable for attachment to the pressure-sensitive adhesive.

Descriptions of the adhesives customarily used for adhesive tapes, and also of release varnishes and primers, are found, for example, in the “Handbook of Pressure Sensitive Adhesive Technology” by Donatas Satas (van Nostrand, 1989).

The adhesive applied to the carrier material is preferably a pressure-sensitive adhesive, this being an adhesive which permits a durable bond to virtually all substrates even under relatively weak applied pressure and which, after use, can be detached from the substrate again substantially without residue. A pressure-sensitive adhesive exerts permanent pressure-sensitive tack at room temperature, thus having a sufficiently low viscosity and a high initial tack, meaning that it wets the surface of the respective bond base even under low applied pressure. The bondability of the adhesive derives from its adhesive properties, and the redetachability from its cohesive properties.

To produce an adhesive tape from the carrier, any known adhesive systems may be employed. In addition to the preferred adhesives based on natural rubber or synthetic rubber, it is possible to use silicone adhesives and also polyacrylate adhesives, preferably a low molecular mass acrylate hotmelt pressure-sensitive adhesive.

The adhesive used is preferably one which consists of the group of the natural rubbers or of any desired blend of natural rubbers and/or synthetic rubbers, the proportion of synthetic rubber in the blend, according to one preferred variant, being at most as great as the proportion of the natural rubber.

Rubber adhesives display a good combination of bond strength, tack and cohesion and also balanced adhesion performance on virtually all relevant substrates, and are therefore predestined. General information on rubber adhesives can be found in sources including standard works for adhesive tapes, such as, for example, the “Handbook of Pressure Sensitive Adhesive Technology” by Donatas Satas.

The natural rubber or natural rubbers may be selected in principle from all available qualities such as, for example, crepe, RSS, ADS, TSR, or CV types, according to the required level of purity and of viscosity, and the synthetic rubber or synthetic rubbers may be selected from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA), and polyurethanes, and/or blends thereof.

Furthermore, preferably, in order to enhance their processing qualities, the rubbers may be admixed with thermoplastic elastomers, with a weight fraction of 10 to 50 wt %, based on the overall elastomer fraction.

Representatives that may be mentioned at this point include in particular the especially compatible styrene-isoprene-styrene (SIS) and styrene-butadiene-styrene (SBS) types. Suitable elastomers for blending are also, for example, EPDM or EPM rubber, polyisobutylene, butyl rubber, ethylene-vinyl acetate, hydrogenated block copolymers of dienes (for example, by hydrogenation of SBR, cSBR, BAN, NBR, SBS, SIS, or IR; such polymers are known, for example, as SEPS and SEBS) or acrylate copolymers such as ACM.

In addition, a 100% system of styrene-isoprene-styrene (SIS) has proven suitable.

Crosslinking is advantageous for improving the repeelability of the adhesive tape after application, and may be accomplished thermally or by irradiation with UV light or electron beams.

For the purpose of thermally induced chemical crosslinking it is possible to use all known thermally activatable chemical crosslinkers such as accelerated sulfur systems or sulfur donor systems, isocyanate systems, reactive melamine-, formaldehyde-, and (optionally halogenated) phenol-formaldehyde resins and/or reactive phenolic resin or diisocyanate crosslinking systems with the corresponding activators, epoxidized polyester resins and acrylate resins, and also combinations thereof.

The crosslinkers are preferably activated at temperatures above 50° C., more particularly at temperatures from 100° C. to 160° C., very preferably at temperatures from 110° C. to 140° C. Thermal excitation of the crosslinkers may also take place via IR rays or high-energy alternating fields.

Use may be made of solventborne, water-based or else hotmelt-system adhesives. An acrylate hotmelt-based adhesive is suitable as well, and may have a K value of at least 20, more particularly greater than 30, obtainable by concentrating a solution of such an adhesive to form a system which can be processed as a hotmelt.

The concentrating may take place in appropriately equipped vessels or extruders; a devolatilizing extruder is preferred, especially where there is accompanying devolatilization.

An adhesive of this kind is set out in DE 43 13 008 A1, the content of which is hereby referenced and made part of the present disclosure and invention.

The acrylate hotmelt-based adhesive, however, may also be crosslinked chemically.

In a further embodiment, self-adhesives used are copolymers of (meth)acrylic acid and esters thereof having 1 to 25 C atoms, maleic, fumaric and/or itaconic acid and/or their esters, substituted (meth)acrylamides, maleic anhydride and other vinyl compounds, such as vinyl esters, more particularly vinyl acetate, vinyl alcohols and/or vinyl ethers.

The residual solvent content ought to be below 1 wt %.

An adhesive which has likewise shown itself to be suitable is a low molecular mass, pressure-sensitive acrylate hotmelt adhesive of the kind carried by BASF under the designation acResin UV or Acronal®, especially Acronal® DS 3458. This low-K-value adhesive acquires its application-compatible properties by virtue of a concluding chemical crosslinking operation initiated by radiation.

Lastly it may be mentioned that polyurethane-based or polyolefin-based adhesives are suitable as well.

For the purpose of optimizing the properties, the self-adhesive employed may have been blended with tackifiers (resins) and/or with one or more adjuvants such as plasticizers, fillers, pigments, UV absorbers, light stabilizers, aging inhibitors, crosslinking agents, crosslinking promoters, or elastomers.

The designation “tackifier resin” is understood by the skilled person to refer to a resin-based substance which increases the tack.

Tackifiers are, for example, especially hydrogenated and nonhydrogenated hydrocarbon resins (composed of unsaturated C₅ or C₇ monomers, for example), terpene-phenolic resins, terpene resins from raw materials such as α- or β-pinene and/or δ-limonene, aromatic resins such as indene-coumarone resins, or resins of styrene or α-methylstyrene, such as rosin and its derivatives, such as disproportionated, dimerized, or esterified resins, in which case glycols, glycerol, or pentaerythritol may be used. Particularly suitable are aging-stable resins without an olefinic double bond, such as hydrogenated resins, for example.

Express reference may be made to the depiction of the state of knowledge in the “Handbook of Pressure Sensitive Adhesive Technology” by Donatas Satas (van Nostrand, 1989).

For the purpose of stabilization, customary adjuvants may be added to the adhesive, such as aging inhibitors (antiozonants, antioxidants, light stabilizers, and so on).

Additives for the adhesive that are typically utilized are as follows:
Plasticizing agents such as, for example, plasticizer oils or low molecular mass liquid polymers such as low molecular mass polybutenes, for example
Primary antioxidants such as sterically hindered phenols, for example
Secondary antioxidants such as phosphites or thiosynergists (thioethers), for example
Process stabilizers such as C-radical scavengers, for example
Light stabilizers such as UV absorbers or sterically hindered amines, for example
Processing assistants
Wetting additives
Adhesion promoters
Endblock reinforcer resins and/or
Optionally further polymers preferably elastomeric in nature; elastomers utilizable accordingly include, among others, those based on pure hydrocarbons, as for example unsaturated polydienes such as natural or synthetically generated polyisoprene or polybutadiene, chemically substantially saturated elastomers such as, for example, saturated ethylene-propylene copolymers, α-olefin copolymers, polyisobutylene, butyl rubber, ethylene-propylene rubber, and also chemically functionalized hydrocarbons such as, for example, halogen-containing, acrylate-containing, allyl or vinyl ether-containing polyolefins
Fillers such as fibers, carbon black, zinc oxide, titanium dioxide, solid microspheres, solid or hollow glass spheres, silica, silicates, chalk.

Suitable fillers and pigments are, for example, fibers, carbon black, zinc oxide, titanium dioxide, solid microbeads, solid or hollow glass beads, silica, silicates, chalk, carbon black, titanium dioxide, calcium carbonate and/or zinc carbonate.

Suitable aging inhibitors (antiozonants, antioxidants, light stabilizers, etc.) for the adhesives are primary antioxidants such as sterically hindered phenols, for example, secondary antioxidants such as phosphites or thiosynergists (thioethers), for example, and/or light stabilizers such as UV absorbers or sterically hindered amines, for example.

Suitable plasticizers are, for example, aliphatic, cycloaliphatic, and aromatic mineral oils, diesters or polyesters of phthalic acid, trimellitic acid, or adipic acid, liquid rubbers (for example, nitrile rubbers or polyisoprene rubbers), liquid polymers of butene and/or isobutene, acrylic esters, polyvinyl ethers, liquid resins and plasticizing resins based on the raw materials for tackifier resins, wool wax and other waxes, or liquid silicones.

Crosslinking agents are, for example, phenolic resins or halogenated phenolic resins, melamine resins and formaldehyde resins. Suitable crosslinking promoters are, for example, maleimides, allyl esters such as triallyl cyanurate, and polyfunctional esters of acrylic and methacrylic acids.

The substances recited are in turn not mandatory; the adhesive also functions without their addition individually or in any combination, in other words without resins and/or residual adjuvants.

The coating thickness with adhesive is preferably in the range from 1 to 100 g/m², more particularly 10 to 50 g/m², more preferably in the range from 15 to 35 g/m².

The pressure-sensitive adhesives may be produced and processed from solution, dispersion, and from the melt. Preferred production and processing methods are from solution or dispersion.

The pressure-sensitive adhesives thus produced may then be applied to the carrier using the methods that are general knowledge. In the case of processing from the melt, these may be application methods involving a die or a calender.

In the case of methods from solution, known coating operations are with doctor blades, knives, or nozzles, to mention but a few.

The adhesive in conjunction with the stated film permits residue-free removal by peeling in the range of the customary usage temperature, which lies between −20° C. and +40° C.

For the purposes of this invention, the general expression “adhesive tape” encompasses all sheetlike structures, such as two-dimensionally extended films or film sections, tapes with extended length and limited width, tape sections and the like, and also, lastly, diecuts or labels.

The adhesive tape may be produced in the form of a roll, in other words in the form of an Archimedean spiral wound up onto itself, or else with lining on the adhesive side using release materials such as siliconized paper or siliconized film.

Suitable release material preferably comprises a nonlinting material such as a polymeric film or a well-sized, long-fiber paper.

The adhesive tapes have running lengths in particular of 1000 to 30 000 m.

The reverse face of the adhesive tape may have had a reverse-face varnish applied to it, in order to exert a favorable influence over the unwind properties of the adhesive tape wound to form an Archimedean spiral. For this purpose, this reverse-face varnish may have been equipped with silicone or fluorosilicone compounds and also with polyvinylstearylcarbamate, polyethyleneiminestearylcarbamide, or organofluorine compounds as substances with abhesive (antiadhesive) effect.

Suitable release agents include surfactant-based release systems based on long-chain alkyl groups such as stearyl sulfosuccinates or stearyl sulfosuccinamates, but also polymers, which may be selected from the group consisting of polyvinylstearylcarbamates, polyethyleneiminestearylcarbamides, chromium complexes of C₁₄ to C₂₈ fatty acids, and stearyl copolymers, as described in DE 28 45 541 A, for example. Likewise suitable are release agents based on acrylic polymers with perfluorinated alkyl groups, silicones or fluorosilicone compounds, for example based on poly(dimethylsiloxanes). With particular preference the release layer comprises a silicone-based polymer. Particularly preferred examples of such silicone-based polymers with release effect include polyurethane-modified and/or polyurea-modified silicones, preferably organo-polysiloxane/polyurea/polyurethane block copolymers, more preferably those as described in example 19 of EP 1 336 683 B1, very preferably anionically stabilized polyurethane-modified and urea-modified silicones having a silicone weight fraction of 70% and an acid number of 30 mg KOH/g. An effect of using polyurethane-modified and/or urea-modified silicones is that the products of the invention combine optimized aging resistance and universal writability with an optimized release behavior. In one preferred embodiment of the invention, the release layer comprises 10 to 20 wt %, more preferably 13 to 18 wt %, of the release-effect constituent.

Adhesive tapes of the invention are used preferably in widths of 9 to 50 mm, more particularly 19 to 25 mm, and in that case have a preferred thickness of 40 to 200 μm, preferably 70 to 180 μm, more preferably 75 to 120 μm.

Roll widths selected are customarily 10, 15, 19, 25 and 30 mm.

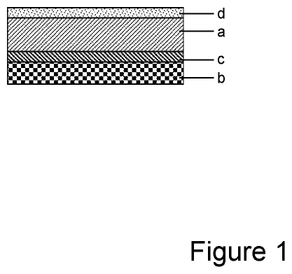

FIG. 1 shows a typical construction of the adhesive tape of the invention.

The product consists of a film (a) and an adhesive (b). Additionally there may also be a primer (c) used, for improving the adhesion between adhesive and carrier, and a reverse-face release (d) may be used as well.

The carrier (a) consists of a monoaxially oriented polypropylene film having a preferred thickness of between 40 and 150 μm.

The adhesive (b) is a mixture of natural rubber or other elastomers and also various resins, and may optionally also include plasticizers, fillers, and aging inhibitors.

The production and processing of the pressure-sensitive adhesives may take place from solution, dispersion, and also from the melt. Preferred production and processing techniques take place from solution and also from the melt. Particularly preferred is the manufacture of the adhesive from the melt, in which case, in particular, batch methods or continuous methods may be employed. Particularly advantageous is the continuous fabrication of the pressure-sensitive adhesives by means of an extruder.

The pressure-sensitive adhesives thus produced may then be applied to the carrier using the methods that are general knowledge. In the case of processing from the melt, these may be application methods involving a die or a calender.

In the case of methods from solution, known coating operations are with doctor blades, knives, or nozzles, to mention but a few.

Heterophasic PP copolymer is envisaged for applications at relatively low temperatures, since the incorporated EP phase enables the material to retain a certain degree of flexibility, even at low temperatures, and to have a greater toughness than PP homopolymers or else PP random copolymers. A weak point of the heterophasic PP copolymers is the decidedly poor attachment of the EP phase to the PP homopolymer phase, since these two phases are not miscible and are therefore present alongside one another. When the adhesive tape is peeled off, therefore, the weakest point is in the attachment between the two polymer phases (EP and PP-homo), with the consequence of shredding within the film. Through the addition of the EPM with a low Young's modulus of elasticity (elasticity modulus, determination via tensile test) and high ethylene fraction, which is already in the EP phase, the ethylene content in the material is increased. Accordingly, the glass transition temperature is shifted to lower temperatures and the material possesses a higher toughness at lower temperatures. Furthermore, the crystallinity in the PP-homo matrix is disrupted, and so there is a higher proportion of amorphous regions, bringing with it a greater flexibility. The effect of the elastomer is to reduce the crystalline fraction in the film and “sticking-together” of the fibrils which are formed when the amorphous phase is stretched in machine direction (reduction in the post-crystallization of the amorphous phase).

Surprisingly, in the case of the film of the invention, the strength in the z-direction and fiber formation, especially under cold conditions, is considerably improved, and the shredding reduced, without any reduction in the elasticity modulus or force at 5% elongation, the most important property for MOPP films.

The adhesive tape of the invention exhibits ready redetachability from a wide variety of substrates at temperatures of down to −20° C. On the other hand, however, redetachability exists even at plus temperatures (+40° C.), meaning that no residues are observed as a result of cohesive failure of the adhesive, nor any adhesive transfer (poor adhesive anchoring), and no carrier splits are observed.

The carrier has a sufficient internal strength in all three directions in space, and has a high impact toughness even at low temperature.

On the basis of the properties outlined, the adhesive tape can be employed outstandingly as an adhesive strapping tape for bundling and palletizing cardboard-boxed items and other goods, even at low temperatures.

Furthermore, the adhesive tape can be used for outstanding fastening of moving parts such as doors, flaps, and the like on printers or refrigerators during transport from the manufacturer to the seller, and on to the purchaser, even at low temperatures.

By virtue of the properties outlined, the adhesive tape of the invention can also be employed advantageously in the following applications:
a) In the temporary fastening of relatively large components such as auto windshields, for example, following insertion into the frame, until the liquid PU adhesive has cured, to prevent slippage during the curing process.
b) In the endtabbing (end-ply bonding) of metal coils, with the requirement for residue-free redetachability even at low temperatures.
c) In the temporary sealing of containers or general bonding to surfaces, with the requirement for residue-free redetachability even at low temperatures.

A significant reduction in splitting of the carrier at low temperature is observed; furthermore, the adhesive tapes are redetachable without residue.

The invention described here, by virtue of the increased internal strength, likewise resolves the formation of fiber in the splitting and converting operation.

The invention is illustrated below by a number of examples, without thereby wishing to impose any restriction on the invention.

### EXAMPLE

All quantity data, fractions, and percent fractions are given by weight “pwb” denotes parts by weight.

### Experimental Protocol

A dry blend is prepared of the heterophasic copolymer with the EPM (preferred concentration 4 to 7 wt %) and is melted by means of a single-screw extruder (at temperatures between from 160 to 240° C.). The melt is formed into a film through a slot die, and is laid down and cooled on a chill roll (at temperatures between 60 to 100° C.). A monoaxial drawing unit is used to orient the film in a short stretching gap process with draw rates of 1:5 to 1:9 (preferably 1:6 to 1:8).

The dry blend consists of 5 wt % of the EPM elastomer Vistalon 722 from ExxonMobil, an ethylene-propylene copolymer having an ethylene content of 72 wt % and also having an MFI (measured at 190° C. under 2.16 kg loading) of 1.0 g/10 min and an elasticity modulus of 1240 MPa, and of 95 wt % of the heterophasic PP copolymer Profax SV 258 from LyondellBasell, having an MFI (measured at 230° C. under 2.16 kg loading) of 1.2 g/10 min and an elasticity modulus of 1240 MPa. The material is melted in a single-screw extruder at temperatures from 180 to 230° C., formed into a flat film with the aid of a slot die, and laid down and cooled on a chill roll with a temperature of 95° C. The thickness of the resulting film is 325 μm. After cooling, the film is again heated to temperatures of 127° C. in a monoaxial drawing unit and oriented in a short gap with a draw rate of 1:6.5, after which it is conditioned at a temperature of 127° C. and finally wound up. Therefore an ultimate film thickness of 50 μm is produced.

### Results

In in-transit securement, the mechanical properties of the film are of central importance. A very soft film will be likely not to exhibit any shredding, but instead will have a very high elongation with little accommodation of force. This would mean that the film would stretch if forces occurred during transit. The adhesive tape would therefore “go slack” instead of holding together the product being transported.

TABLE 1
Mechanical properties and shredding
results for various MOPP films

| Material | F5 % [N/mm²] | Fmax [N/mm²] | Shredding |
|---|---|---|---|
| MOPP film | 76 | 273 | Fail |
| Profax SV 258 | 112 | 328 | Fail |
| Profax SV 258 + | 110 | 328 | Fail |
| 2.5 wt % Vistalon 722 | | | |
| Profax SV 258 + | 108 | 317 | Pass |
| 5 wt % Vistalon 722 | | | |
| Profax SV 258 + | 103 | 315 | Pass |
| 10 wt % Vistalon 722 | | | |

As can be seen in table 1, the addition of Vistalon 722 lowers the mechanical properties only slightly as compared with the pure heterophasic copolymer. At a concentration of 5 wt %, however, the film passes the shredding test. Concentration of 10 wt % of Vistalon has no further advantage over 5 wt % of Vistalon, and so a concentration of around 5 wt % is preferred. The MOPP film investigated for comparison purposes in the Tesa® 64294 adhesive tape, furnished with a natural rubber adhesive, has a significantly lower accommodation of force. Moreover, the film fails the shredding test.

### Test Methods

The measurements are carried out (unless indicated otherwise) under test conditions of 23±1° C. and 50±5% relative humidity.

### Shredding

The films are aged for 2 weeks and then pretreated with a corona dose of 60.7 W*min/m² at a speed of 30 m/min in order to increase the surface energy and therefore the anchorage to a d/s adhesive tape. The film is laminated to a suitable adhesive tape, for example Tesa® 61795 PV40 or Tesa® 4965 PV0, and slit to form strips 20 mm wide. Tesafix® 4965 is a double-sidedly adhesive, transparent polyester tape bearing an acrylate adhesive.

The properties of Tesa® 4965 are as follows:
carrier material: PET film
thickness: 205.00 μm
adhesive: modified acrylate
elongation at break: 50.00%
tearing force: 20.00 N
peel adhesion on steel (initial): 11.50 N/cm
peel adhesion on ABS (initial)
10.30 N/cm peel adhesion on aluminum (initial): 9.20 N/cm
peel adhesion on PC (initial): 12.60 N/cm
peel adhesion on PE (initial): 5.80 N/cm
peel adhesion on PET (initial): 9.20 N/cm
peel adhesion on PP (initial): 6.80 N/cm
peel adhesion on PS (initial): 10.60 N/cm
peel adhesion on PVC (initial): 8.70 N/cm

These assemblies are subsequently adhered to an ABS test plate cleaned with ethanol, and are stored at room temperature for 24 hours. The film is subsequently removed from the double-sided adhesive tape by hand, at three different speeds and angles: at 90° slowly, at 180° slowly, and then at 180° quickly. This test is likewise carried out after storage for 24 hours at −20° C. The test is passed if, after the film has been peeled off, there are no residues of film remaining on the adhesive.

### Tensile Test and Elasticity Modulus

According to DIN ISO 527: On a tensile testing machine, a film strip 15 mm wide is clamped in a clamping jaw spacing of 100 mm. The tensile test is carried out at a velocity of 300 mm/min to tearing point. The maximum tensile force Fmax and the force at 5% elongation (F5%) are ascertained from the measurement curve. The values are reported in N/mm², meaning that the measurement value is standardized to the film thickness. The elasticity modulus is ascertained from the force-elongation curve at low elongation in accordance with DIN ISO 527.

### Degree of Crystallization

The degree of crystallization is determined by the method as described in the article by Schubnell, M.: “Determination of the crystallinity for polymers from DSC measurements”; Mettler Toledo Deutschland; de.mt.com; USERCOM vol. 1, 2001, pages 12 to 13.

In this case the degree of crystallization is ascertained by means of a DSC measurement at a heating rate of 10 K/min explicitly from the free enthalpy of the 1st heating curve, assuming a value of 207 J/g (literature value) for the enthalpy of fusion of a 100% crystalline homo-PP.

### Peel Adhesion

The determination of the peel adhesion (in accordance with AFERA 5001) is carried out as follows: the defined substrate used is galvanized steel sheet with a thickness of 2 mm (obtained from Rocholl GmbH). The bondable sheetlike element under test is cut to a width of 20 mm and a length of about 25 cm, provided with a handling section, and immediately thereafter pressed five times using a 4 kg steel roller, with a rate of advance of 10 m/min, onto the selected substrate. Immediately after that, the bondable sheetlike element is peeled from the substrate at an angle of 180° using a tensile testing instrument (from Zwick) at a velocity v=300 mm/min, and the force needed to achieve this at room temperature is recorded. The measured value (in N/cm) is obtained as the average from three individual measurements.

### Melt Index (MFI)

The melt index (MFI) is measured according to ISO 1133. For polyethylenes it is determined at 190° C. and with a weight of 2.16 kg, for polypropylenes at a temperature of 230° C. and a weight of 2.16 kg.

### Flexural Modulus (Flexural Elasticity Modulus)

The test takes place according to ASTM D 790 A (2% secant), in other words according to Procedure A (see also section 1 of the ASTM) with a test specimen for determining the flexural modulus, with dimensions of 0.125″×0.5″×5.0″ (3.2 mm×12.7 mm×125 mm).

### Crystallite Melting Point

The crystallite melting point of copolymers, hard blocks and soft blocks, and uncured reactive resins is determined calorimetrically via differential scanning calorimetry (DSC) according to DIN 53765:1994-03. Heating curves run with a heating rate of 10 K/min. The specimens are subjected to measurement in Al crucibles with perforated lid and a nitrogen atmosphere. Evaluation takes place on the second heating curve. In the case of amorphous substances, glass transition temperatures occur; in the case of (semi)crystalline substances, melting temperatures occur. A glass transition can be recognized as a step in the thermogram. The glass transition temperature is evaluated as the center point of this step. A melting temperature can be perceived as a peak in the thermogram. The melting temperature recorded is the temperature at which the maximum heat change occurs.

### Density

The density is measured according to ASTM D 792.

### Molecular Weight Determination

The molecular weight determinations of the weight-average molecular weights M_{w} were made by means of gel permeation chromatography (GPC). The eluent used was THF (tetrahydrofuran) with 0.1 vol % of trifluoroacetic acid. Measurement took place at 25° C. The pre-column used was PSS-SDV, 5μ, 10³ Å, ID 8.0 mm×50 mm. Separation took place using the columns PSS-SDV, 5μ, 10³ and also 105 and 106 each with ID 8.0 mm×300 mm. The sample concentration was 4 g/l, the flow rate 1.0 ml per minute. Measurement was made against PMMA standards.

1. An adhesive tape having a carrier comprising a film bearing on at least one side an applied adhesive, wherein:
the film is a monoaxially oriented film which comprises at least 95 wt %, of a propylene polymer composition having different phases and comprising the following components:
i) 80 to 99 wt %, based on the total weight of components i) and ii), of a propylene polymer matrix which comprises a propylene homopolymer and further preferably including a preferably random propylene copolymer having a comonomer which is selected from ethylene or C₄ to C₁₀ α-olefins, the comonomer content of the propylene polymer matrix being not more than 15 wt %;
ii) 1 to 20 wt %, based on the total weight of components i) and ii), of an elastomer in the form of an ethylene-propylene copolymer having an ethylene content of 50 to 90 wt %.

2. The adhesive tape of claim 1, wherein
the propylene polymer composition consists essentially of components i) and ii).

3. The adhesive tape of claim 1, wherein
the fractions of propylene homopolymer and of propylene copolymer in component i) are
70 to 99 wt % propylene homopolymer and
1 to 30 wt % propylene copolymer.

4. The adhesive tape of claim 1, wherein
the propylene polymer matrix has:
a melt flow index MFI of 0.5 to 10 g/10 min (measured as claimed in ISO 1133 at 230° C. and under a weight of 2.16 kg) and,
an elasticity modulus of 1000 to 1300 MPa.

5. The adhesive tape of claim 1, wherein
the polypropylene homopolymer comprises granules whose only polymer is polypropylene.

6. The adhesive tape of claim 1, wherein:
ethylene is selected as comonomer in the propylene copolymer, with an ethylene-propylene ratio of 0.9:1 to 1.1:1.

7. The adhesive tape of claim 1, wherein:
the ethylene content in the elastomer in the form of an ethylene-propylene copolymer is 55 to 80 wt %.

8. The adhesive tape of claim 1, wherein:
the melting point (DSC) of the elastomer is less than 70° C.

9. The adhesive tape of claim 1, wherein:
the degree of crystallinity of component ii) is 0.1.

10. The adhesive tape of claim 1, wherein:
the draw ratio on orientation of the extruded primary film in longitudinal direction is 1:5 to 1:9.

11. The adhesive tape of claim 1, wherein:
the film thickness after orientation is between 40 and 150 μm.

12. The adhesive tape of claim 1, wherein:
the adhesive is selected from natural rubbers or from a blend of natural rubbers and synthetic rubbers.

13. The adhesive tape of claim 1, wherein:
the adhesive comprises at least one tackifier resin.

14. The adhesive tape of claim 1, wherein:
the adhesive comprises at least one UV stabilizer and/or other blending components.

15. A method of securing movable parts on printers, copiers, or household appliances comprising the step of:
applying an adhesive tape according to claim 1 between the moveable parts.

16. An adhesive strapping tape for bundling and palletizing cardboard-boxed items which adhesive strapping tape is an adhesive tape according to claim 1.

17. The adhesive tape of claim 13, wherein:
the tackifier resin is selected from: resins based on hydrogenated, partly-hydrogenated or unhydrogenated hydrocarbon resins, terpene-phenols and rosin esters.

18. The adhesive tape of claim 14, wherein:
the at least one UV stabilizer and/or other blending component is selected from: plasticizers, aging inhibitors, processing assistants, fillers, dyes, optical brighteners, stabilizers, and endblock reinforcer resins.
